(19) United States
(12) Patent Application Publication
(10) Pub. No.: US 2017/0284524 A1
(43) Pub. Date: Oct. 5, 2017

(54) BEVEL RING GEAR WITH INTEGRATED PLANETARY DIFFERENTIAL

(71) Applicant: Schaeffler Technologies AG & Co. KG, Herzogenaurach (DE)

(72) Inventor: Brian Lee, York, SC (US)

(73) Assignee: Schaeffler Technologies AG & Co. KG, Herzogenaurach (DE)

(21) Appl. No.: 15/471,048

(22) Filed: Mar. 28, 2017

Related U.S. Application Data
(60) Provisional application No. 62/316,181, filed on Mar. 31, 2016.

(51) Int. Cl. F16H 48/10; F16H 48/38; F16H 55/17

(52) U.S. Cl. CPC F16H 48/10; F16H 55/17; F16H 48/38; F16H 2048/108; F16H 2048/385

(57) ABSTRACT

A bevel gear assembly for a vehicle includes a housing, a side plate, and a plurality of planet gears. The housing has an outer bevel gear profile and a first annular ring. The side plate is fixed to the housing and has a second annular ring. The plurality of planet gears is disposed axially between the first and second annular rings. In some example embodiments, the bevel gear assembly has a plurality of planet pins extending through respective planet gears of the plurality of planet gears. In an example embodiment, each of the planet pins of the plurality of planet pins extend through respective apertures in each of the first and second annular rings.

### FIELD

The invention relates generally to a planetary differential, and more specifically to a planetary differential integrated with a bevel ring gear.

### BACKGROUND

Planetary, or spur gear, differentials are known. One example is shown and described in commonly assigned U.S. Pat. No. 8,221,278 to Biermann et al., hereby incorporated by reference as if set forth fully herein. Other examples are shown in U.S. Pat. Nos. 3,375,735 and 3,738,192, European Patent No. 0130806 B1, and French Patent Application Publication No. 2611016 A1.

The following description is made with reference to FIG. 1. FIG. 1 is a schematic view of a prior art box bevel gear differential assembly. Another example is shown and described in U.S. Pat. No. 1,893,255 to Tracy. Differential assembly 100 includes pinion gear 102 fixed to shaft 104 and bevel gear 106 fixed to housing 108. Shafts 110 and 112 extend through housing 108 and are fixed to spider gears 114 and 116, respectively. Cross shaft 118 is fixed to housing 108 at either end. Spider gears 120 and 122 are rotatably mounted on cross shaft 118. That is, spider gears 120 and 122 are rotatable relative to cross shaft 118. Bearings 124 and 126 support housing 108, and bearing 128 supports pinion shaft 104.

Although gears 114, 116, 120 and 122 are depicted with gaps therebetween, the spider gears are actually in meshing engagement. That is, each of the gears includes respective tooth profiles that are drivingly engaged with adjacent gears. Similarly, pinion 102 and bevel gear 106 are in meshing engagement. Torque from pinion 102 is transmitted to housing 108 via bevel gear 106. The particular configuration of spider gears 114, 116, 120, and 122 allows shafts 110 and 112 to spin at different speeds, as is commonly known in the art.

### BRIEF SUMMARY

Example embodiments broadly comprise a bevel gear assembly for a vehicle including a housing, a side plate, and a plurality of planet gears. The housing has an outer bevel gear profile and a first annular ring. The side plate is fixed to the housing and has a second annular ring. The plurality of planet gears is disposed axially between the first and second annular rings. In some example embodiments, the bevel gear assembly has a plurality of planet pins extending through respective planet gears of the plurality of planet gears. In an example embodiment, each of the planet pins of the plurality of planet pins extend through respective apertures in each of the first and second annular rings.

In some example embodiments, the bevel gear assembly has first and second hubs with respective inner spline profiles and outer gear teeth profiles. In an example embodiment, the respective inner spline profiles share a common pitch diameter and the respective outer gear profiles have different pitch diameters. In some example embodiments, the bevel gear assembly has first and second thrust washers with respective radial walls. At least a portion of the first thrust washer radial wall is disposed axially between the first hub and the first annular ring, and at least a portion of the second thrust washer radial wall is disposed axially between the second hub and the second annular ring. In some example embodiments, the first and second thrust washers have respective cylindrical protrusions extending in axially opposite directions from the respective first and second radial walls. In an example embodiment, the first thrust washer cylindrical protrusion circumscribes a portion of the first hub and the second thrust washer cylindrical protrusion circumscribes a portion of the second hub.

In an example embodiment, the housing has a central axis and the plurality of planet gears include respective central axes parallel and radially offset from the housing central axis. In an example embodiment, a first set of the plurality of planet gears has a first axial width and a second set of the plurality of planet gears has a second width greater than the first width. In some example embodiments, the plurality of planet gears includes a first set of the plurality of planet gears in meshing engagement with a second set of the plurality of planet gears. In an example embodiment, the bevel gear assembly has first and second hubs. The first set of planet gears is in meshing engagement with the first hub and the second set of planet gears is in meshing engagement with the second hub.

In an example embodiment, the side plate is fixed to the housing by bolts. In some example embodiments, the bevel gear assembly has first and second bearings. The first bearing is disposed within a bore of the housing and the second bearing circumscribes or is disposed within a cylindrical wall of the side plate. In an example embodiment, each of the first and second bearings include respective contact angles extending in a same axial direction. In an example embodiment, each of the first and second bearings include respective contact angles extending in opposite axial directions.

### BRIEF DESCRIPTION OF THE DRAWINGS

The nature and mode of operation of the present invention will now be more fully described in the following detailed description taken with the accompanying drawing figures, in which:

FIG. 1 is a schematic view of a prior art box bevel gear differential assembly;

FIG. 2 is a front perspective view of a bevel gear assembly with a sideplate removed for clarity;

FIG. 3 is a back view of the bevel gear assembly of FIG. 2;

FIG. 4 is a section view of the bevel gear assembly of FIG. 3 taken generally along line 4-4 in FIG. 3;

FIG. 5 is a section view of an alternative embodiment of the bevel gear assembly of FIG. 3 with a different bearing arrangement taken generally along line 5-5 in FIG. 3;

FIG. 6 is a section view of the alternative embodiment of FIG. 5 taken generally along line 6-6 in FIG. 5.

### DETAILED DESCRIPTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

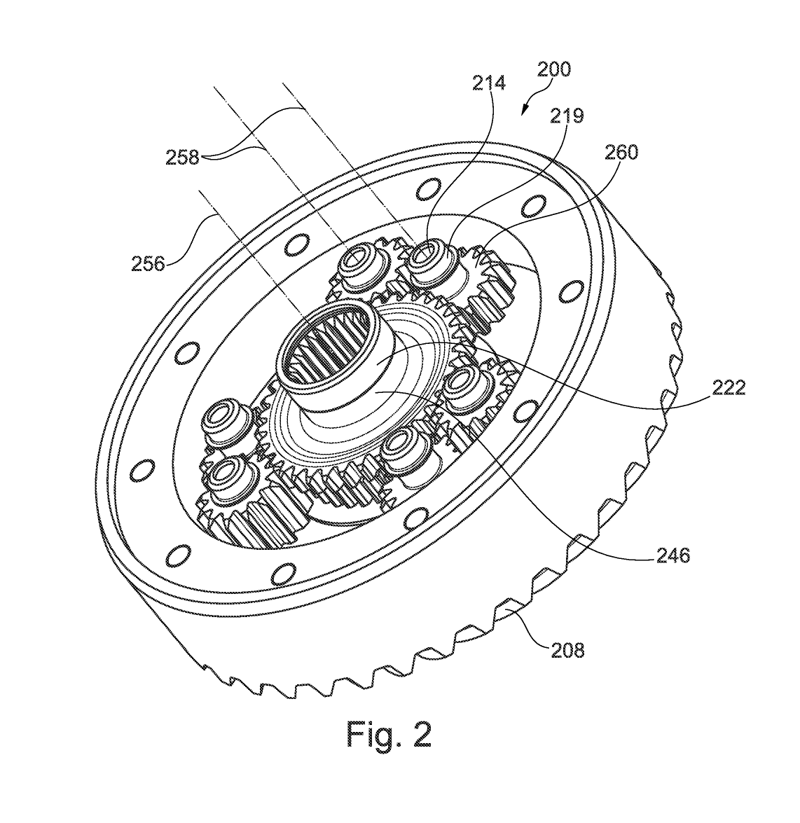

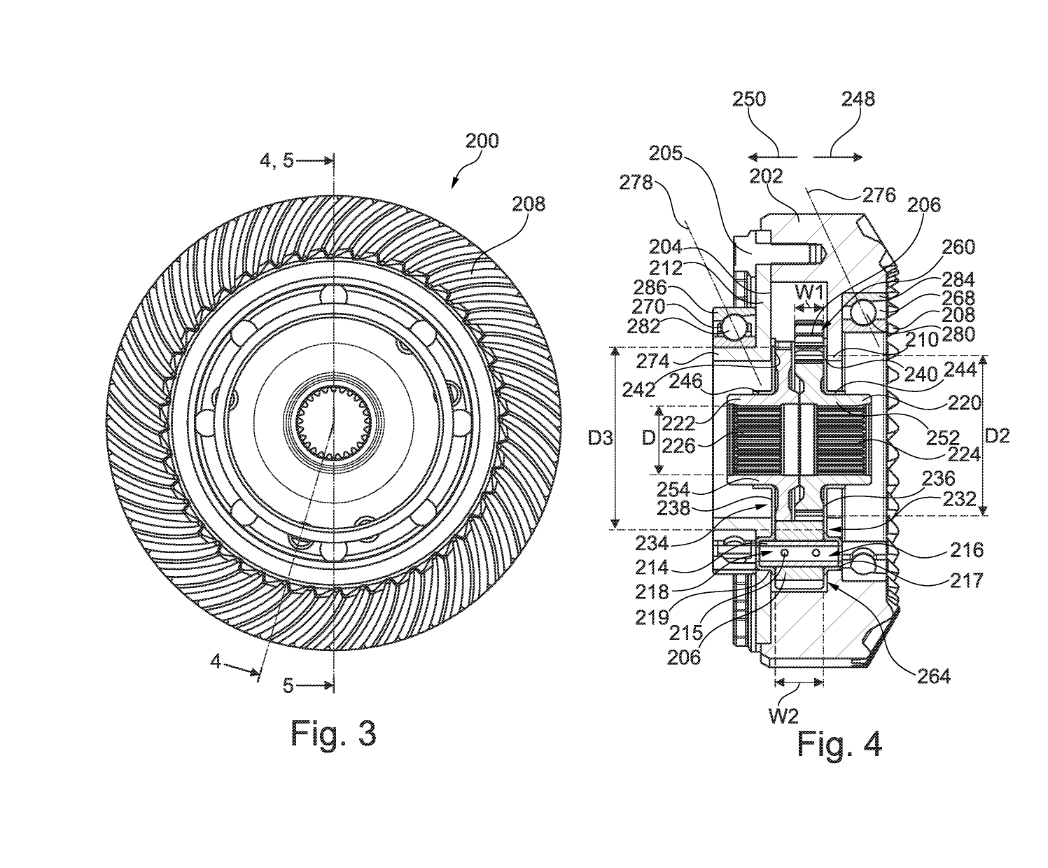

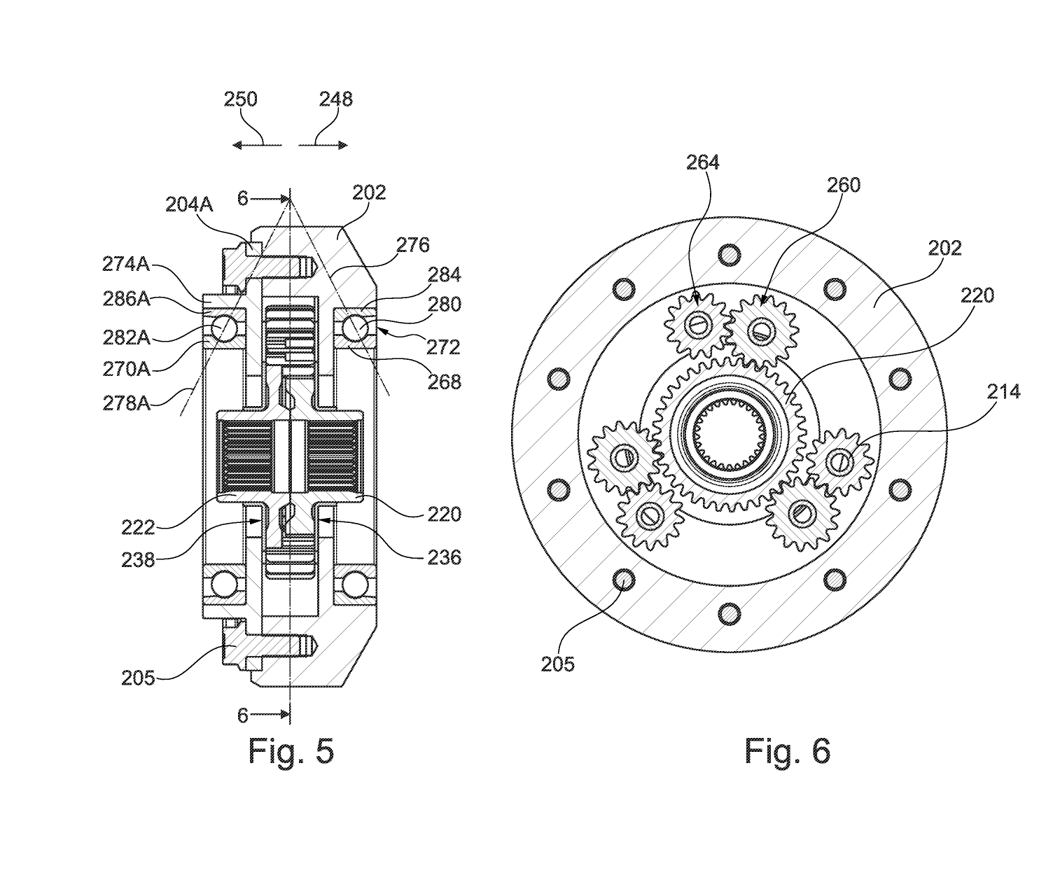

The following description is made with reference to FIGS. 2-6. FIG. 2 is a front perspective view of bevel gear assembly 200 with a sideplate removed for clarity according. FIG. 3 is a back view of the bevel gear assembly of FIG. 2. FIG. 4 is a section view of the bevel gear assembly of FIG. 3 taken generally along line 4-4 in FIG. 3. FIG. 5 is a section view of an alternative embodiment of the bevel gear assembly of FIG. 3 showing a different bearing arrangement taken generally along line 5-5 in FIG. 3. FIG. 6 is a section view of the alternative embodiment of FIG. 5 taken generally along line 6-6 in FIG. 5.

Bevel gear assembly 200 is for a vehicle such as an automobile. Assembly 200 includes housing 202, side plate 204 (or 204A as shown in FIG. 5—204A may be substituted for 204 in the following description except where noted) and planet gears 206. Housing, or bevel style ring gear, 202 has outer bevel gear profile 208 and annular ring 210. Side plate, or carrier plate, 204 is fixed to housing 202 and has annular ring 212. Plate 204 may be fixed to the housing by bolts 205 or by welds (not shown), for example. Planet gears 206 are disposed axially between annular rings 210 and 212. Assembly 200 further includes planet pins 214 extending through respective planet gears 206. In the example embodiment shown, planet pins 214 are hollow and include lubrication holes 215. Each of the planet pins extend through respective apertures 216 and 218 in annular rings 210 and 212. Sleeves 217 and 219 aid in positioning of pins 214 and gears 206.

Assembly 200 includes hubs 220 and 222 with respective inner spline profiles 224 and 226, and outer gear teeth profiles 228 and 230. Inner spline profiles 224 and 226 share common pitch diameter D1 and the outer gear profiles 228 and 230 have different pitch diameters D2 and D3. Assembly 200 includes thrust washers 232 and 234 with respective radial walls 236 and 238. Portion 240 of radial wall 236 is disposed axially between hub 220 and annular ring 210. Portion 242 of radial wall 238 is disposed axially between hub 222 and annular ring 212. Thrust washers 232 and 234 include respective cylindrical protrusions 244 and 246 extending in axially opposite directions 248 and 250 from respective radial walls 236 and 238. Cylindrical protrusion 244 circumscribes portion 252 of hub 220 and cylindrical protrusion 246 circumscribes portion 254 of hub 222.

Housing 202 includes central axis 256 and planet gears 206 include respective central axes 258 parallel and radially offset from the housing central axis. Set 260 of planet gears 206 has axial width W1 and set 264 of planet gears 206 has width W2 greater than width W1. As best seen in FIG. 6, set 260 of planet gears 206 is in meshing engagement with set 264 of planet gears 206. Set 260 of planet gears 206 is in meshing engagement with hub 220 and set 264 of planet gears 206 is in meshing engagement with hub 222.

Assembly 200 further includes bearings 268 and 270. Bearing 268 is disposed within bore 272 of housing 202 and bearing 270 circumscribes cylindrical wall 274 of side plate 204 (as shown in FIG. 4) or is disposed within cylindrical wall 274A of side plate 204A (as shown by bearing 270A in FIG. 6). Bearings 268 and 270 have respective contact angles 276 and 278 extending axial direction 250 (as shown in FIG. 4) or in opposite axial directions 250 and 248 (as shown by contact angles 276 and 278A in FIG. 5). That is, the angle that balls 280 and 282 contact respective outer rings 284 and 286 is up and to the left when viewed in the top half of the cross section of FIG. 4. In another embodiment, ball 282A contacts outer ring 286A up and to the right when viewed in the top half of the cross section of FIG. 5.

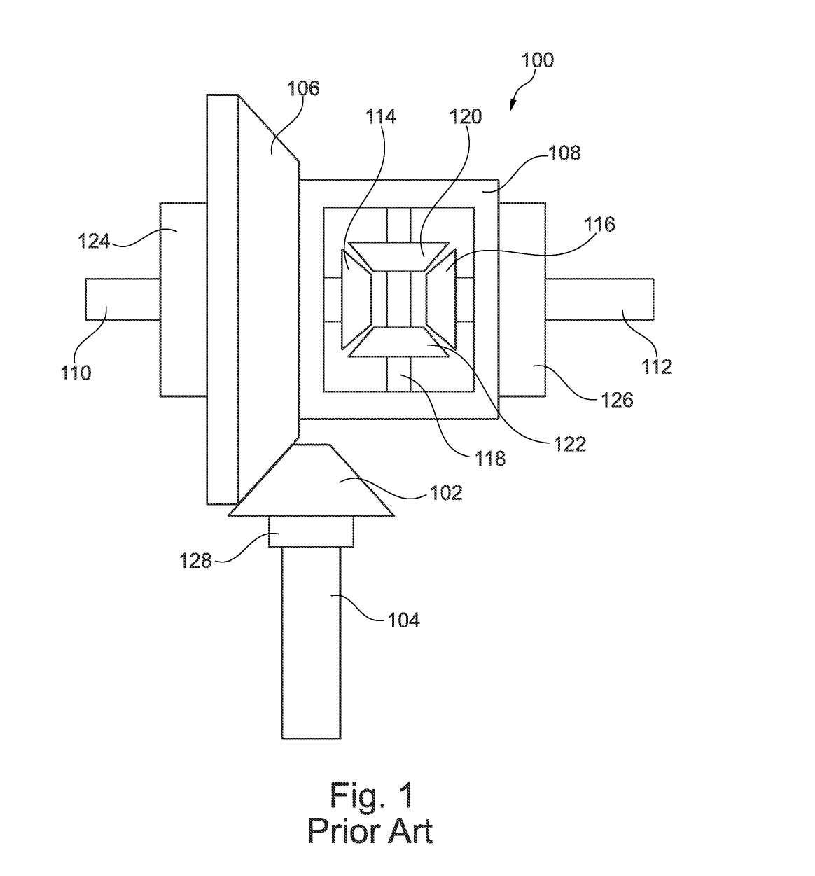

The bearings advantageously support the bevel gear assembly in a differential housing (not shown) to maintain proper alignment with a pinion gear (not shown but similar to pinion gear 102 in FIG. 1). Although angular contact ball bearings are shown in the example embodiment, other types of bearings (i.e., angular roller bearings) are possible and should be considered within the scope of the invention. Although 6 pinion gears 206 are shown (i.e., 3 each in set 260 and 264), other numbers of pinion gears 206 are possible, though generally an even number of pinion gears is preferred.

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

What we claim is:

1. A bevel gear assembly for a vehicle comprising:
a housing comprising an outer bevel gear profile and a first annular ring;
a side plate fixed to the housing and comprising a second annular ring; and,
a plurality of planet gears disposed axially between the first and second annular rings.

2. The bevel gear assembly of claim 1 further comprising a plurality of planet pins extending through respective planet gears of the plurality of planet gears.

3. The bevel gear assembly of claim 2 wherein each of the planet pins of the plurality of planet pins extend through respective apertures in each of the first and second annular rings.

4. The bevel gear assembly of claim 1 further comprising first and second hubs with respective inner spline profiles and outer gear teeth profiles.

5. The bevel gear assembly of claim 4 wherein the respective inner spline profiles share a common pitch diameter and the respective outer gear profiles have different pitch diameters.

6. The bevel gear assembly of claim 4 further comprising first and second thrust washers with respective radial walls, wherein at least a portion of the first thrust washer radial wall is disposed axially between the first hub and the first annular ring, and at least a portion of the second thrust washer radial wall is disposed axially between the second hub and the second annular ring.

7. The bevel gear assembly of claim 6 wherein the first and second thrust washers comprise respective cylindrical protrusions extending in axially opposite directions from the respective first and second radial walls.

8. The bevel gear assembly of claim 7 wherein the first thrust washer cylindrical protrusion circumscribes a portion of the first hub and the second thrust washer cylindrical protrusion circumscribes a portion of the second hub.

9. The bevel gear assembly of claim 1 wherein the housing comprises a central axis and the plurality of planet gears include respective central axes parallel and radially offset from the housing central axis.

10. The bevel gear assembly of claim 1 wherein a first set of the plurality of planet gears has a first axial width and a second set of the plurality of planet gears has a second width greater than the first width.

11. The bevel gear assembly of claim 1 wherein the plurality of planet gears comprises a first set of the plurality of planet gears in meshing engagement with a second set of the plurality of planet gears.

12. The bevel gear assembly of claim 11 further comprising first and second hubs, wherein the first set of planet gears is in meshing engagement with the first hub and the second set of planet gears is in meshing engagement with the second hub.

13. The bevel gear assembly of claim 1 wherein the side plate is fixed to the housing by bolts.

14. The bevel gear assembly of claim 1 further comprising first and second bearings, wherein the first bearing is disposed within a bore of the housing and the second bearing circumscribes or is disposed within a cylindrical wall of the side plate.

15. The bevel gear assembly of claim 14 wherein each of the first and second bearings include respective contact angles extending in a same axial direction.

16. The bevel gear assembly of claim 14 wherein each of the first and second bearings include respective contact angles extending in opposite axial directions.
